(19) United States
(12) Patent Application Publication
(10) Pub. No.: US 2002/0042825 A1
(43) Pub. Date: Apr. 11, 2002

(54) Internet based telephony service method

(75) Inventor: Min Gu Gee, Seoul (KR)

Correspondence Address: Jonathan Y. Kang, Esq., Lee & Hong P.C., 221 N. Figueroa Street, 11th Floor, Los Angeles, CA, 90012-2601, US

(73) Assignee: ATPHONE TELECOM Co., Ltd.

(21) Appl. No.: 09/728,024

(22) Filed: Nov. 30, 2000

(30) Foreign Application Priority Data
Oct. 5, 2000 (KR) 2000-0058494

(51) Int. Cl. G06F 15/16

(52) U.S. Cl. 709/227; 709/230

(57) ABSTRACT

There is provided an Internet based telephony service method in which an identification code, a country code and an area code each of which is composed of only figures are used when a call is made using a telephony service system operating on the Internet, thereby allowing users to become familiar with Internet phone numbers and use them easily and thereby automatically allocating e-mail addresses and UMS to the Internet phone numbers such that they have standardized characteristic numbers. The Internet based telephony service method constructed in a certain manner that an identification code for establishing a call connection route is assigned to a specific position corresponding to the head of a telephone number to be stored in a management server; and upon transmission of a call request signal to the management server via the Internet, the code located at the specific position of the head of a transmitted telephone number is extracted and then the call connection route is determined on the basis of the extracted code.

### BACKGROUND OF THE INVENTION

1. Field of the Invention

The present invention relates to an Internet based telephony service method and, more particularly, to an Internet based telephony service method in which an identification code, a country code and an area code each of which is configured of only figures are assigned to a specific position in a telephone number used when a call is made between a wire telephone using a public switched telephone network (PSTN) or a mobile phone using a wireless communication network and an Internet phone driven by a personal computer or a dedicated Internet phone via the Internet, thereby allowing users to become familiar with Internet phone numbers and use them easily and thereby automatically allocating electronic mail (e-mail) addresses and UMS to the Internet phone numbers such that they have standardized characteristic numbers.

2. Description of the Related Art

As is generally known, telephone based communication uses a wire telephone making a call through a public switched telephone network (PSTN), mostly installed in a home or office, and a mobile phone for radio communication via mobile communication base stations. In case where the wire telephone and mobile phone are used for a long-distance call and international call, users should pay large amount of telephone charges than those for a local call. Accordingly, free telephony service using an Internet, called “Internet phone service”, is recently developed and used. Since the users pay only charges for using communication service when they use the Internet phone service for the international call or long-distance call, the Internet phone service is being widely spread in the fashion of free phone service for purposes of making advertisement profits.

An Internet phone service method is divided into a method of accessing the web page of an Internet service provider (ISP) and a method of previously installing a program for driving the Internet phone in the computer of an Internet phone user. In the former method, an Internet connection program such as a web browser operates on the user's computer to connect to the server of a telephony service provider on the Internet and then an Internet phone provided through the web page is driven to attempt a telephone call. In the latter, an Internet phone including a browser capable of connecting to the telephony service provider's server on the Internet is downloaded to the user's computer to be installed therein and then the Internet phone operates to make a call.

An analog voice signal of a sender is converted to a digital signal using a built-in or external microphone added to a personal computer, notebook computer, palm-top computer, pocket computer, PDA and the like, which are capable of connecting to the Internet using a built-in or external modem (telephone modem, cable modem or wireless modem) and, simultaneously, the digital signal is compressed in real time (for example, 64K is compressed down to 5.3K, 6.3K or 8K on the basis of G.723 or G.729) to be transmitted by packets to the receiving part through the Internet using a transmission protocol such as H.323 (protocol established by ITU for providing real-time multimedia communication between networks), RSVP, RTP/RTCP and the like. The receiving part decodes the compressed digital signal in real time and converts it into the analog signal to output the converted analog signal through a voice outputting devices such as built-in or external speaker, headphone or earphone. By doing so, the sending part and receiving part can communicate with each other in real time.

In usage of the Internet phone, however, it takes time to make a call because the user's computer is first turned on to be booted up, the program for driving the web browser or Internet phone is driven to access the Internet and then a telephone number is inputted in order to attempt the connecting with a desired receiving part. Accordingly, the fact is that the Internet phone is not rapidly replacing the conventional wire telephones and mobile phones due to the complicated process for making a call in spite of the advantages of free telephony service.

To overcome this shortcoming of the Internet phone, new Internet phone was proposed, which has buttons for inputting telephone numbers externally attached thereto, and it is similar to those of general wire telephones, as it contains a built-in modem, a built-in one-chip micro-controller unit functioning as a computer and a digital signal processor for real-time compressing or decompressing voice signals that have been converted into digital data. This allows its user being able to use the Internet phone only by pushing the buttons in the same manner as the conventional telephone, without needing any separate booting procedure or program driving procedure required for making a call on the Internet. Owing to this kind of Internet phone, calls can be made from Internet phone to general wire telephone or mobile phone or from wire telephone or mobile phone to Internet phone.

In the conventional telephony service system using the aforementioned Internet phone, however, e-mail address from the receiving part of which consists by a combination of characters and figures should be used when a call is made from the general wire telephone or mobile phone to the Internet phone or personal computer. This is confused with the conventional telephone numbering system configured only by figures and customarily used for the general telephone, and results in checking the spread of Internet phones.

### SUMMARY OF THE INVENTION

The object of the present invention is, therefore, to provide a method of Internet based telephony service in which an identification code, a country code and an area code each, composed of only figures, are used when a call is made using a telephony service system by operating on the Internet, thereby allowing users to become familiar with Internet phone numbers and to allocate e-mail addresses and UMS automatically by using the numbers easily, such that the characteristic numbers are standardized.

To accomplish the object of the present invention, there is provided an Internet based telephony service method, comprising the steps of assigning an identification code for establishing a call connection route to a specific position corresponding to the head of a telephone number to store it in a management server; upon transmission of a call request signal to the management server via the Internet, extracting the code located at the specific position of the head of a transmitted telephone number; and determining the call connection route is determined on the basis of the extracted code.

In embodiments of the present invention, when an identification code and a telephone number are inputted and then an e-mail transmission signal is transmitted to a management server, a data storage of the management server stores the transmitted content in an e-mail storing space therein, the e-mail storing space having the identification code and the telephone number as an e-mail address.

### BRIEF DESCRIPTION OF THE DRAWINGS

FIG. 1 illustrates an Internet based telephony service system in accordance with the present invention;

FIG. 2 is a flow chart for explaining an Internet based telephony service method in accordance with the present invention; and

FIG. 3 illustrates protocols applied to the Internet based telephony service system in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

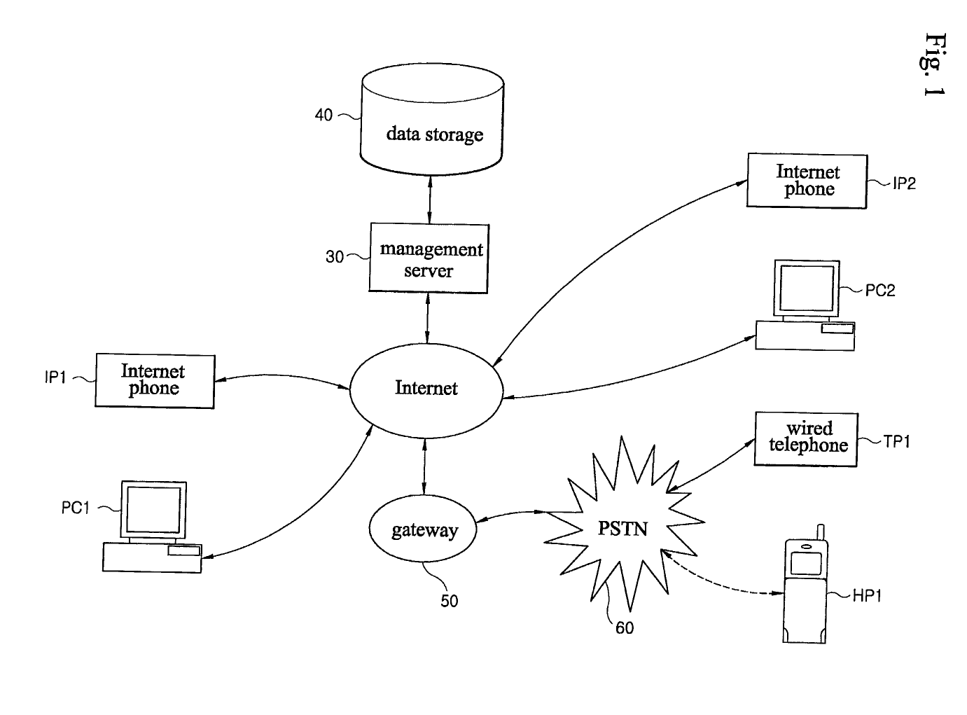

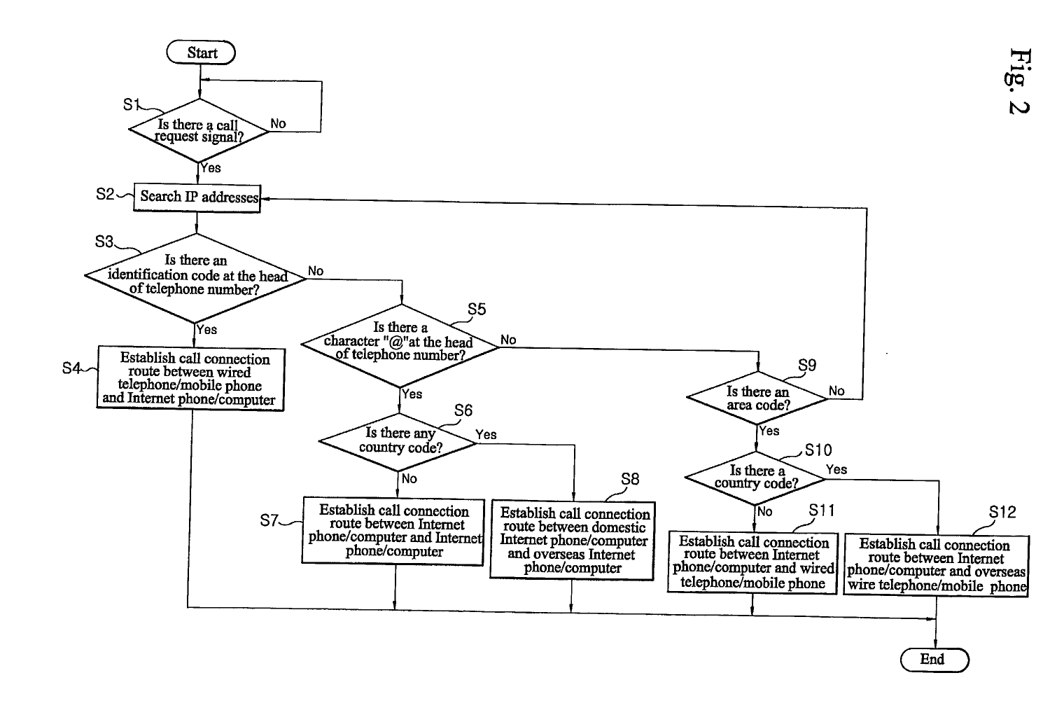

As shown in FIGS. 1 and 2, an identification code for establishing a call connection route is assigned to a specific position corresponding to the head of a telephone number to be stored in the data storage 40 of a management server 30. Upon transmission of a call request signal to the management server 30 via the Internet, a code positioned at the head of a transmitted telephone number is extracted and the call connection route is established on the basis of the extracted code. The identification code is composed of Arabic figures. In case of 022-3453-2792, for example, “022” located at the head of this telephone number corresponds to the identification code. The call connection route determined by the identification code could be a call connection route connected from the wired telephone using the public switched telephone network (PTSN) or mobile phone to the Internet phone via the Internet.

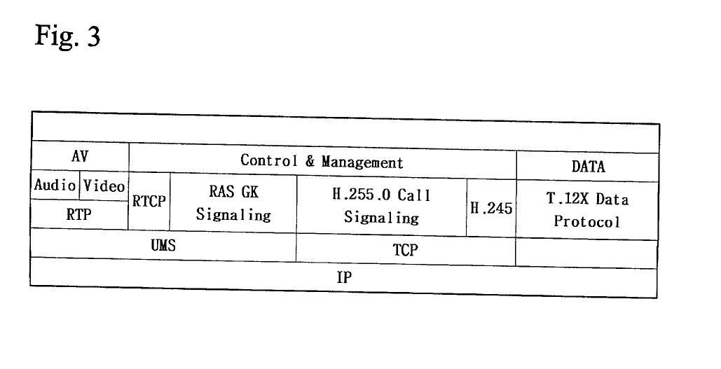

When an e-mail transmission signal is transferred to the management server after inputting of an identification code and a telephone number, the data storage of the management server stores the transmitted content in an e-mail storing space therein, the electronic mail storing space having the identification code and telephone number as an e-mail address. FIG. 3 shows voice-over Internet protocols for transmitting/receiving voice data via the Internet.

The Internet based telephony service method according to the present invention will be explained in more detail with reference to the attached drawings.

Referring to FIGS. 1 and 2, when a call request signal is generated by an Internet phone IP1 or IP2, computer PC1 or PC2, a mobile phone HP1 or a wired telephone TP1 (step S1), the management server 30 searches IP addresses in order to recognize the terminal that generated the call request signal and the kind of that terminal (step S2) and then it judges if the identification code is located at the head of the transmitted telephone number. When there is the identification code at the head of the telephone number, the call connection route is established between the wired telephone TP1 or mobile phone HP1 and the Internet phone IP1 or IP2 or computer PC1 or PC2 (steps S3 and S4). On the other hand, when the identification code is not placed at the head of the telephone number, instead “@” exists, it is judged that there was a call request made from the Internet phone IP or computer PC1 to the other Internet phone IP2 or computer CP2. Then, it is judged that the call is an international call or domestic call (step S5). If a country code follows the character “@”, the call is judged to be the international call to establish the call connection route between the domestic Internet phone IP1 or computer PC1 and the overseas Internet phone IP2 or computer PC2. When any country code is not found after detection of the “@”, the call is judged to be the domestic call to form the call connection route between the domestic Internet phone IP1 or computer CP1 and the other domestic Internet phone IP2 or computer CP2 (steps S6, S7 and S8).

Meantime, when there exists an area code instead of the identification code or “@” at the head of the telephone number, it is judged that the call request is made from the Internet phone IP1 or IP2 or computer CP1 or CP2 to the wired telephone TP1 or mobile phone HP1 and then judged that the call is an international call or a domestic call (step S9). If the country code is found after detection of the area code, the call is judged to be the international call to establish the call connection route between the domestic The Internet phone IP1 or computer PC1 to the overseas Internet phone IP2 or computer PC2. When the country code does not follow the area code, the call is judged to be the domestic call to form the call connection route between the domestic Internet phone IP1 or computer CP1 to the other domestic wired telephone TP1 or mobile phone HP1 (steps S10, S11 and S12).

Meanwhile, when the user inputs an identification code and a telephone number and then requests the management server 30 to transmit an e-mail having the identification code and telephone number, the data storage 40 of the management server 40 automatically stores the transmitted content in the e-mail storing space therein, the electronic mail storing space having the identification code and telephone number as an electronic mail address.

As described above, since the Internet based telephony service method of the present invention uses the packet-based network, the users are not needed to pay charges for international call service as well as the domestic call service when they use them. In addition, it is possible to transmit not only voice information but also image information so that even picture communication is available.

It will be readily seen by one of ordinary skill in the art that the present invention fulfills the object described above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

What is claimed is:

1. An Internet based telephony service method, comprising the steps of:
assigning an identification code for establishing a call connection route to a specific position corresponding to the head of a telephone number to store it in a management server;
upon transmission of a call request signal to the management server via the Internet, extracting the code located at the specific position of the head of a transmitted telephone number; and
determining the call connection route is determined on the basis of the extracted code.

2. The Internet based telephony service method according to claim 1, wherein the identification code is configured of Arabic figures.

3. The Internet based telephony service method according to claim 1, further comprising a step of recognizing a country code or area code which follows the identification code.

4. The Internet based telephony service method according to claim 3, wherein the country code and area code are configured of Arabic figures.

5. The Internet based telephony service method according to claim 1, wherein the call connection route established on the basis of the identification code is a call connection route connected from a wired telephone using a public switched telephone network or mobile phone to an Internet phone via the Internet.

6. An Internet based telephony service method, wherein, when an identification code and a telephone number are inputted and then an e-mail transmission signal is transferred to a management server, data storage of the management server stores the transmitted content in an e-mail storing space therein, the e-mail storing space having the identification code and the telephone number as an e-mail address.
